(19) United States
(12) Patent Application Publication
(10) Pub. No.: US 2012/0325580 A1
(43) Pub. Date: Dec. 27, 2012

(54) Tether Device And Method

(76) Inventor: Scott C. Yocco, Racine, WI (US)

(21) Appl. No.: 13/167,364

(22) Filed: Jun. 23, 2011

(51) Int. Cl. A62B 35/00; B23P 11/00

(52) U.S. Cl. 182/3; 29/428

(57) ABSTRACT

A method and device is provided for tethering an elevated individual to a fall arresting anchor. The device includes a tether strap having first and second opposite ends. The tether strap defines first and second loop portions positionable about corresponding shoulders of the individual and being movable between a first open configuration allowing a corresponding shoulder to be positioned therein and a second configuration for capturing the corresponding shoulder to be positioned. A tether point is defined by the first and second ends of the tether strap and is connectable to an anchor. A belt is operatively connected to the tether strap and is positionable about a waist of the individual.

### FIELD OF THE INVENTION

This invention relates generally to fall prevention devices, and in particular, to a fall prevention device for tethering an individual to an anchor while the individual is in an elevated position.

### BACKGROUND AND SUMMARY OF THE INVENTION

By way of background, hunters, while hunting, often seek elevated perches, such as tree stands, to gain an improved vantage point over the surrounding landscape. Such elevated tree stands are often accessed by way of a ladder or by manually scaling the side of the tree in what is referred to as a climbing tree stand. Regardless of the style of tree stand utilized, the stands are similar in that they provide an elevated platform from which the hunter can survey the surrounding landscape while hunting. Once elevated, however, the hunter is at risk of falling out of the stand and becoming injured.

It can be appreciated that most traditional tree stands are intended to support a single hunter. Accordingly, if a hunter were to fall out of a tree stand and become injured, it is possible that no one would be in the immediate vicinity to provide the required first aid. Such risk of injury is further compounded by the fact that most hunting occurs in remote locations, far from populated areas where one might successfully call for required assistance. Additionally, falling from a tree stand may result in accidentally discharging a firearm or dislodging a sharpened blade such as a hunting knife or arrow, thereby further increasing the risk of physical injury.

As is known, many tree stands incorporate safety measures such as a seatbelt or a restraining line to limit the occurrence of such falls. However, these safety measures are often integrated into the tree stand. As such, if the tree stand were to disengage from the tree, the safety measure would not arrest the hunter's fall. Alternatively, some of these safety measures, namely seatbelts, can limit the hunter's mobility and thereby inhibit the hunter's effectiveness. Further, many of these safety measures are incompatible with the bulky clothing necessary for hunting in cold weather climates.

Therefore, it is a primary object and feature of the present invention to provide fall prevention harness which securely tethers an individual to an anchor while the individual is in an elevated position.

It is a further object and feature of the present invention to provide a coat incorporating a fall prevention harness which securely tethers an individual to an anchor while the individual is in an elevated position.

It is still a further object and feature of the present invention to provide a coat incorporating a fall prevention harness which securely tethers an individual to an anchor while the individual is in an elevated position and which maintains the individual within the coat in the event that the individual falls from the elevated position.

In accordance with the present invention, a tether device for a wearer is provided. The wearer has shoulders. The device includes a tether strap having first and second opposite ends. The tether strap defines first and second loop portions positionable about corresponding shoulders of the wearer. The first and second loop portions are movable between a first open configuration allowing a corresponding shoulder to be positioned therein and a second configuration for capturing the corresponding shoulder positioned therein. A tether point is defined by the first and second ends of the tether strap. The tether point is connectable to an anchor. First and second connection straps have first ends connected to the tether strap and second ends. A belt is operatively connected to the connection straps and is positionable about a waist of the wearer. The belt includes first and second ends.

The tether strap includes a cross strap portion interconnecting the first and second loop portions and a connection structure connects the first and second ends of the tether strap to form the tether point. A fastening mechanism is operatively connected to the first and second ends of the belt. The fastening mechanism is moveable between an open configuration wherein the first and second ends of the belt are disconnected and a second closed position wherein the first and second ends of the belt are interconnected.

The device may also include a coat. The coat includes a torso portion for positioning about a torso of the wearer. The torso portion has an inner surface defining an interior of the torso portion for receiving the tether strap therein and an outer surface. First and second arm portions extend from the torso portion. Each arm portion has an interior communicating with the interior of the torso portion for receiving corresponding arms of the wearer. The torso portion includes first and second apertures therethrough. The first and second ends of the belt extend through corresponding apertures in the torso portion of the coat. A liner has a first portion received within the torso portion and arm receiving portions received within the arm portions. A guide may be operatively connected to the tether strap. The guide defines at least one passageway for receiving the first and second ends of the tether strap therethough.

In accordance with a further aspect of the present invention, a tether device for a wearer is provided. The wearer has shoulders. The device includes a tether strap having first and second opposite ends. The tether strap has first and second loop portions positionable about corresponding shoulders of the wearer. The first and second loop portions are movable between a first open configuration allowing a corresponding shoulder to be positioned therein and a second configuration for capturing the corresponding shoulder. A tether point is defined by the first and second ends of the tether strap. The tether point is connectable to an anchor. A belt is operatively connected to the tether strap and is positionable about a waist of the wearer. The belt includes first and second ends.

The tether strap includes a cross strap portion interconnecting the first and second loop portions. A connection structure is provided for connecting the first and second ends of the tether strap to form the tether point. A fastening mechanism is operatively connected to the first and second ends of the belt. The fastening mechanism is moveable between an open configuration wherein the first and second ends of the belt are disconnected and a second closed position wherein the first and second ends of the belt are interconnected.

The coat includes a torso portion for positioning about a torso of the wearer. The torso portion has an inner surface defining an interior of the torso portion for receiving the tether strap therein and an outer surface. First and second arm portions extend from the torso portion. Each arm portion has an interior communicating with the interior of the torso portion for receiving corresponding arms of the wearer. The torso portion may include first and second apertures therethrough. The first and second ends of the belt extend through corresponding apertures in the torso portion of the coat. A liner has a first portion received within the torso portion and arm receiving portions received within the arm portions. A guide may operatively connected to the tether strap. The guide defines at least one passageway for receiving the first and second ends of the tether strap therethough.

In accordance with a still further aspect of the present invention, a method is provided of tethering an individual to an elevated anchor. The method includes the step of placing a tethering harness on an individual. The harness includes a tether strap having a first end and a second end. A belt is affixed around a waist of the individual. The belt is operatively connected to the tether strap. The first and second ends of the tether strap are interconnected to the elevated anchor.

The step of placing the tethering harness on the individual includes the additional steps of forming first and second loops from the tether strap and positioning the first and second loops over corresponding shoulders of the individual.

If the individual is displaced from an elevated location, the first and second loops are constricted around the shoulders of the individual so as to prevent the falling of the individual from the elevated location. The method may also include the additional step of incorporating the tethering harness into a coat prior to the step of placing the tethering harness on a individual.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of a tether device in accordance with the present invention incorporated into a coat worn by an individual;

FIG. 2 is an isometric view of the tether device of the present invention worn by an individual; and

FIG. 3 is an enlarged isometric view the tether device of the present invention.

### DETAILED DESCRIPTION OF THE DRAWINGS

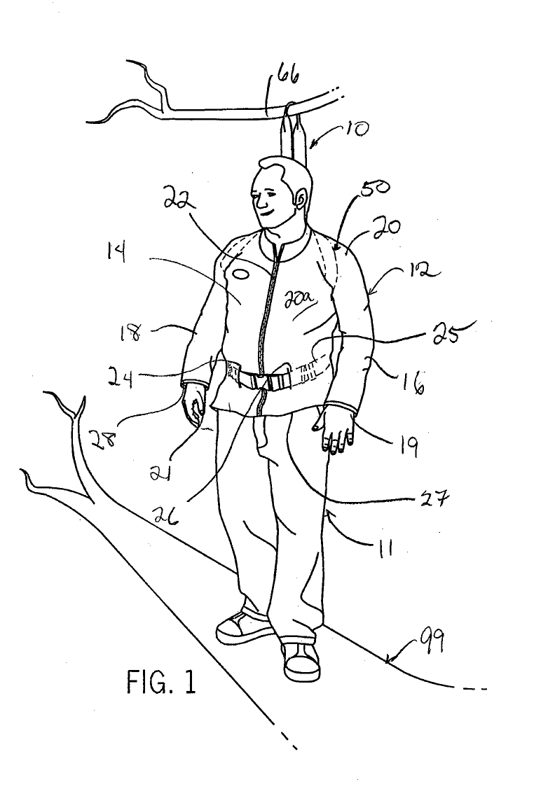

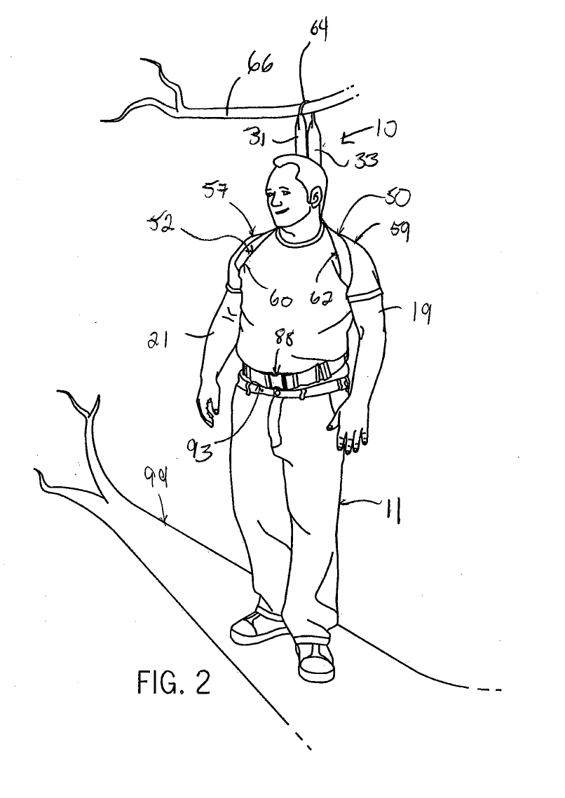

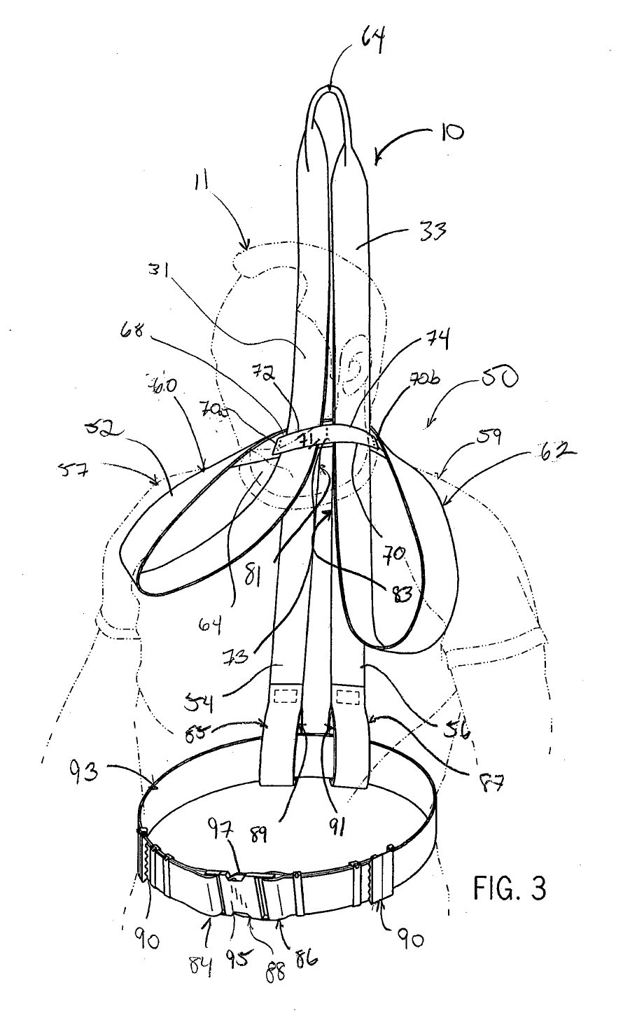

Referring to FIGS. 1-3, a tether device in accordance with the present invention is generally designated by the reference numeral 10. By way of example, it is contemplated for tether device 10 to be incorporated into a garment, such as coat 12, FIG. 1. However, it can be appreciated that tether device 10 may be incorporated into other types of clothing, such as a fireman's jacket, without deviating from the scope of the present invention. Alternatively, as best seen in FIGS. 2-3, it can be appreciated that tether device 10 worn by an individual 11 without being incorporating a coat or the like.

Referring back to FIG. 1, coat 12 includes central torso portion 14 having first arm portion 16 projecting from a first side thereof and second arm portion 18 projecting from an opposite second side thereof. Coat 12 is further defined by exterior layer 20 and a liner 28 secured to the inner surface of the exterior layer 20. Exterior surface 20a of exterior layer 20 may include customized stylistic components to facilitate hunting while wearing the coat 12. By way of example, exterior surface 20a of exterior layer 20 may include a camouflage pattern, such that individual 11 wearing coat 12 is less visually recognizable. The camouflage pattern may vary as to imitate the local flora of the location in which individual 11 is hunting. Alternatively, exterior surface 20a of exterior layer 20 may be highly visible, such as being formed with a blaze orange or safety orange color. The high visibility of exterior surface 20a of exterior layer 20 allows individual 11 to be visually distinguished from the surrounding environment.

Liner 28 of coat 12 is intended to provide additional thermal insulation to individual 11, as is often required of hunting in cold climates. Liner 28 may be permanently affixed to the interior surface of the coat 12, or alternatively, may be removably received along the interior surface of exterior layer 20 of coat 12, such that individual 11 may chose to add or remove the liner 28 to coat 12, in accordance to temperature requirements. The inner surface of liner 28 in torso portion 14 defines a cavity for receiving the torso of individual 11 therein.

Torso portion 14 further includes a longitudinally extending closure mechanism 22. Closure mechanism 22 is movable between an open configuration for allowing individual 11 to enter or remove coat 12 and a closed configuration for maintaining coat 12 on individual 11. The first and second arm portions 16 and 18, respectively, of coat 12 include cavities for receiving right and left arms 19 and 21, respectively, of individual 11. The cavities for receiving the right and left arms 19 and 21, respectively, of individual 11 are interconnected to and in communication with the cavity defined by the inner surface of liner 28 of torso portion 14, such that the coat 12 may be worn by individual 11 in a conventional manner.

Liner 28 and exterior layer 20 of torso portion 14 of coat 12 define belt passage 25 therebetween. It is contemplated for belt passage 25 to extend circumferentially in torso portion 14 at a location adjacent lower cuff 27 of coat 12 so as to encircle the waist line of individual 11 wearing coat 12, for reasons hereinafter described. Belt passage 25 terminates at corresponding first and second belt apertures 24 and 26, respectively, which extend through exterior layer 20 of coat 12 at locations on opposite sides of longitudinal closure 22. Alternatively, apertures (not shown) may extend through liner 28 of coat 12 at locations on opposite sides of longitudinal closure 22.

Tether device 10 further includes tether harness 50 incorporated into coat 12 between exterior layer 20 and liner 28, as hereinafter described. As best seen in FIG. 3, tether harness 50 includes an elongated, flexible strap 52 formed from single piece of webbed material. Strap 52 terminates at first and second ends 31 and 33, respectively, which are joined together by sewing, permanent or releasable fasteners, or the like at tether point 64 to form a single, continuous loop. As best seen in FIG. 1, first and second ends 31 and 33, respectively, of strap 52 extend through an aperture (not shown) in external layer 20 of coat 12 such that tether point 64 is external of coat 12. It is intended for strap 52 to be configured to form first arm loop 60 and a second arm loop 62 which are adapted for receipt over corresponding shoulders 57 and 59, respectively, of individual 11 as hereinafter described.

First and second loops 60 and 62, respectively, are interconnected by cross portion 68 of strap 52 which is intend to pass behind neck 64 of individual 11. Guide 70 has first and second opposite ends 70a and 70b, respectively, and is defined by an inner face and outer face 71. Guide 70 is interconnect at first and second opposite ends 70a and 70b, respectively, and at intermediate location 73 to the interior surface of the cross portion 68 of strap 52 so as to define first and second passageways 72 and 74, respectively. It is intended for first and second ends 31 and 33, respectively, of strap 52 to be slidably received in corresponding first and second passageways 72 and 74, respectively, and to be maintained in a centrally located position relative to torso portion 14 of coat 12.

Tether harness 50 further includes first connection strap 54 and second connection strap 56, respectively, incorporated into coat 12 between exterior layer 20 and liner 28. First and second connection straps 54 and 56, respectively, have upper ends 81 and 83, respectively, affixed to corresponding first and second ends 31 and 33, respectively, of strap 52 and lower ends 85 and 87, respectively. Lower ends 85 and 87, respectively, of first and second connection straps 54 and 56, respectively, are positioned in belt passage 25 between external layer 20 and liner 28 and are folded upon themselves so as to form passages 89 and 91 for receiving belt 93, as hereinafter described. It is intended for passages 89 and 91 to be positioned adjacent to each other and to the waist line of individual 11 wearing coat 12. Alternatively, lower ends 85 and 87, respectively, of first and second connection straps 54 and 56, respectively, may be directly connected to belt 93 at locations adjacent the opposite ends 84 and 86 thereof, for reasons hereinafter described.

As previously noted, belt 93 extends through passages 89 and 91 of first and second connection straps 54 and 56, respectively, and through belt passage 25 between exterior layer 20 and liner 28. Belt 93 includes a first end 84 extending through first belt aperture 24 in exterior layer 20 of coat 12 and a second end 86 extending through second belt aperture 26 in exterior layer 20 of coat 12. First end 84 of belt 93 includes male connector 95 adapted for selectively receiving female connector 97 interconnected to second end 86 of belt 93 in a mating relationship. Male connector 95 and female connector 97 define mated mechanism 88 which resides against exterior layer 20 of the coat 12 in the locked configuration. Fastening mechanism 88 provides individual 11 with a simple structure for securing tether harness 50 to individual 11. It is contemplated to provide belt 93 with at least one adjustment mechanism 90 along the length thereof to allow individual 11 to adjust overall length of belt 93 such that belt 93 may be worn securely around or near the waist line of individual 11. Alternatively, it can be appreciated that other types of fastening mechanisms and/or adjustment mechanisms may be used to interconnect first and second ends 84 and 86, respectively, of belt 93 and adjust the length thereof, without deviating from the scope of the present invention.

In operation, with closure mechanism 22 in its open configuration, individual 11 puts coat 12, incorporating tether device 10, on in a conventional manner such that first arm loop 60 and a second arm loop 62 are received over corresponding shoulders 57 and 59, respectively, of individual 11. Closure mechanism 22 is moved to its closed configuration, and male connector 95 and female connector 97 are brought into mating relationship. The length of belt 93 is adjusted by the adjustment mechanisms 90 to secure coat 12 around or near the waist line of individual 11. Thereafter, once individual 11 has moved to a desired, elevated position, tether point 64 of tether harness 50 can be secured to an elevated anchor, e.g. tree branch 66, suitable for arresting the fall of individual 11 and for supporting the weight of individual 11, FIG. 2. With tether point 64 secured to an anchor, such as tree branch 66, it can be appreciated that tether device 10 does not inhibit individual's 11 range of motion, mobility or flexibility as required of hunting related movements. Further, it is noted that no significant force is exerted upon tether point 64, as the weight of individual 11 is distributed over the elevated platform, e.g. tree limb 99.

In the event that individual 11 falls from or becomes otherwise displaced from the elevated platform, gravity pulls individual 11 downwardly so as to exert a force upon tether point 64 and tighten first and second arm loops 60 and 62, respectively, about shoulders 57 and 59, respectively, of individual 11. With first and second arm loops 60 and 62, respectively, tightened about shoulders 57 and 59, respectively, of individual 11, individual 11 is retained within tether device 10, and hence coat 12. As such, individual 11 is suspended from tether point 64 by strap 52 of tether device 10 in an elevated position, thereby preventing individual from falling to the ground and becoming injured. It is intended for a portion of the weight of individual 11 to be partially distributed along first and second connection straps 54 and 56, respectively, and into belt 93. In addition, a portion of the weight of individual may be distributed throughout torso portion 14 and/or first and second arm portions 16 and 18, respectively, of coat 12. In the embodiment wherein lower ends 85 and 87, respectively, of first and second connection straps 54 and 56, respectively, are directly connected to belt 93 at locations adjacent the opposite ends 84 and 86 thereof, the weight of individual 11 is primarily supported by belt 93 and first and second connection straps 54 and 56, respectively, with first and second arm loops 60 and 62, respectively, about shoulders 57 and 59, respectively, providing secondary support.

As previously described, tether harness 50 may be worn and used by individual 11 independent of the coat 12, FIGS. 2-3. More specifically, in operation, individual 11 puts on tether harness 50 such that first arm loop 60 and a second arm loop 62 are received over corresponding shoulders 57 and 59, respectively, of individual 11. Male connector 95 and female connector 97 are brought into mating relationship and the length of belt 93 is adjusted by the adjustment mechanisms 90. Thereafter, once individual 11 has moved to a desired, elevated position, tether point 64 of tether harness 50 can be secured to an elevated anchor, e.g. tree branch 66, suitable for arresting the fall of individual 11 and for supporting the weight of individual 11. With tether point 64 secured to an anchor, such as tree branch 66, it can be appreciated that tether harness 50 does not inhibit individual's 11 range of motion, mobility or flexibility as required of hunting related movements. Further, it is noted that no significant force is exerted upon tether point 64, as the weight of individual 11 is distributed over the elevated platform, e.g. tree limb 99.

In the event that individual 11 falls from or becomes otherwise displaced from the elevated platform, gravity pulls individual 11 downwardly so as to exert a force upon tether point 64 and tighten first and second arm loops 60 and 62, respectively, about shoulders 57 and 59, respectively, of individual 11. With first and second arm loops 60 and 62, respectively, tightened about shoulders 57 and 59, respectively, of individual 11, individual 11 is retained within tether harness 50. As such, individual 11 is suspended from tether point 64 by strap 52 of tether harness 50 in an elevated position, thereby preventing individual from falling to the ground and becoming injured. As heretofore described, it is intended for a portion of the weight of individual 11 to be partially distributed along first and second connection straps 54 and 56, respectively, and into belt 93. In the embodiment wherein lower ends 85 and 87, respectively, of first and second connection straps 54 and 56, respectively, are directly connected to belt 93 at locations adjacent the opposite ends 84 and 86 thereof, the weight of individual 11 is primarily supported by belt 93 and first and second connection straps 54 and 56, respectively, with first and second arm loops 60 and 62, respectively, about shoulders 57 and 59, respectively, providing secondary support.

Various modes of carrying out the invention are contemplated as being within the scope of the following claims particularly pointing out and distinctly claiming the subject matter which is regarded as the invention.

I claim:

1. A tether device for a wearer, the wearer having shoulders, comprising:
a tether strap having first and second opposite ends, the tether strap including:
first and second loop portions positionable about corresponding shoulders of the wearer, the first and second loop portions movable between a first open configuration allowing a corresponding shoulder to be positioned therein and a second configuration for capturing the corresponding shoulder positioned therein; and
a tether point defined by the first and second ends of the tether strap, the tether point connectable to an anchor;
first and second connection straps having first ends connected to the tether strap and second ends; and
a belt operatively connected to the connection straps and being positionable about a waist of the wearer, the belt includes first and second ends.

2. The device of claim 1 wherein the tether strap includes a cross strap portion interconnecting the first and second loop portions.

3. The device claim 1 further comprising a connection structure for connecting the first and second ends of the tether strap to form the tether point.

4. The device of claim 1 further comprising a fastening mechanism operatively connected to the first and second ends of the belt, the fastening mechanism moveable between an open configuration wherein the first and second ends of the belt are disconnected and a second closed position wherein the first and second ends of the belt are interconnected.

5. The device of claim 1 further comprising a coat, the coat including:
a torso portion for positioning about a torso of the wearer, the torso portion having an inner surface defining an interior of the torso portion for receiving the tether strap therein and an outer surface; and
first and second arm portions extending from the torso portion, each arm portion having an interior communicating with the interior of the torso portion for receiving corresponding arms of the wearer.

6. The device of claim 5 wherein the torso portion includes first and second apertures therethrough, the first and second ends of the belt extending through corresponding apertures in the torso portion of the coat.

7. The device of claim 5 further comprising a liner having a first portion received within the torso portion and arm receiving portions received within the arm portions.

8. The device of claim 1 further comprising a guide operatively connected to the tether strap, the guide defining at least one passageway for receiving the first and second ends of the tether strap therethough.

9. A tether device for a wearer, the wearer having shoulders, comprising:
a tether strap having first and second opposite ends, the tether strap including:
first and second loop portions positionable about corresponding shoulders of the wearer, the first and second loop portions movable between a first open configuration allowing a corresponding shoulder to be positioned therein and a second configuration for capturing the corresponding shoulder; and
a tether point defined by the first and second ends of the tether strap, the tether point connectable to an anchor; and
a belt operatively connected to the tether strap and being positionable about a waist of the wearer, the belt includes first and second ends.

10. The device of claim 9 wherein the tether strap includes a cross strap portion interconnecting the first and second loop portions.

11. The device claim 9 further comprising a connection structure for connecting the first and second ends of the tether strap to form the tether point.

12. The device of claim 8 further comprising a fastening mechanism operatively connected to the first and second ends of the belt, the fastening mechanism moveable between an open configuration wherein the first and second ends of the belt are disconnected and a second closed position wherein the first and second ends of the belt are interconnected.

13. The device of claim 9 further comprising a coat, the coat including:
a torso portion for positioning about a torso of the wearer, the torso portion having an inner surface defining an interior of the torso portion for receiving the at least a portion of the tether strap therein and an outer surface; and
first and second arm portions extending from the torso portion, each arm portion having an interior communicating with the interior of the torso portion for receiving corresponding arms of the wearer.

14. The device of claim 13 wherein the torso portion includes first and second apertures therethrough, the first and second ends of the belt extending through corresponding apertures in the torso portion of the coat.

15. The device of claim 13 further comprising a liner having a first portion received within the torso portion and arm receiving portions received within the arm portions.

16. The device of claim 9 further comprising a guide operatively connected to the tether strap, the guide defining at least one passageway for receiving the first and second ends of the tether strap therethough.

17. A method of tethering an individual to an elevated anchor, the method comprising the steps of:
placing a tethering harness on the individual, the harness including a tether strap having a first end and a second end;
affixing a belt around a waist of the individual, the belt being operatively connected to the tether strap; and
interconnecting the first and second ends of the tether strap to the elevated anchor.

18. The method of claim 17 wherein the step of placing the tethering harness on the individual includes the steps of:
forming first and second loops from the tether strap; and
positioning the first and second loops over corresponding shoulders of the individual.

19. The method of claim 18 comprising the additional steps of:
displacing the individual from an elevated location; and
constricting first and second loops around the shoulders of the individual so as to prevent the falling of the individual from the elevated location.

20. The method of claim 12 further comprising the step of incorporating the tethering harness into a coat prior to the step of placing the tethering harness on the individual.
